(19) United States
(12) Patent Application Publication
(10) Pub. No.: US 2015/0162774 A1
(43) Pub. Date: Jun. 11, 2015

(54) METHOD AND APPARATUS FOR DRAWING POWER FROM A BATTERY

(71) Applicant: PowerClip LLC, Brooklyn, NY (US)

(72) Inventors: Robin Reid, Brooklyn, NY (US); Federico Zannier, Seattle, WA (US); Philip Groman, Oakland, CA (US); Surya A. Mattu, Brooklyn, NY (US)

(73) Assignee: PowerClip LLC, Brooklyn, NY (US)

(21) Appl. No.: 14/102,045

(22) Filed: Dec. 10, 2013

(51) Int. Cl. H02J 7/00

(52) U.S. Cl. CPC H02J 7/0065; H02J 7/0045

(57) ABSTRACT

A portable device capable of drawing power from a battery is provided. In an embodiment, the portable device can be slideably adjusted to be positioned over the positive and negative terminals of any sized battery regardless of the distance or orientation of the positive and negative terminals of the battery. Once positioned over the positive and negative terminals of the battery, the device is capable of drawing power from the battery and stepping down the power or converting the power from DC power to AC power so that the stepped down power or AC power can be used to power a portable device.

### FIELD OF THE INVENTION

The present disclosure relates generally to methods and apparatuses for drawing power from a battery, and more specifically to drawing power from an automobile battery to power or charge an electronic device or appliance.

### BACKGROUND

Millions of people lose power every year due to natural disasters and other causes. Many times, these power outages can last several days or even weeks. Recently, Hurricane Sandy left over eight million homes in the eastern United States without power.

When such power outages occur, most people have relatively few sources of power to charge or power various devices such as cellular phones, computers and other household devices and appliances. Portable generators can be used to power household devices and appliances, but such generators are oftentimes expensive to purchase and operate and difficult to store.

Automobile batteries, such as car, truck, motorcycle and moped batteries, are a source of power often unaffected by large-scale power outages. Automobile batteries are typically about 6 V or 12 V of DC power, however, and cannot simply be connected to typical household devices and appliances to provide power to the devices and appliances. Automobile phone chargers exist that may be plugged into an automobile's cigarette lighter, but such devices typically require a user to turn on an automobile and let the automobile run while charging a cellular phone, or at the very least require the automobile itself to be present. Such chargers also typically only allow a user to charge a single device at a time.

Because automobile batteries are often easily obtained during power outages, either from one's own personal automobile or by purchase from an automobile supply store, there is a need for a simple device that can be attached directly to an automobile battery and used to draw power from the automobile battery, step down the power from the battery or convert DC power from the battery to AC power, and provide the stepped down or AC power to charge or power consumer devices and appliances. There is also a need for such a device to be small and compact so that the device can easily be stored, for example, in one's automobile. Besides being useful during power outages, such a device could be useful, for example, to provide power on camping trips or events where the only local source of power is an automobile battery.

### SUMMARY

The present disclosure provides methods and apparatuses for drawing power from a battery. In a general embodiment, a portable device capable of drawing power from a battery includes a first housing including a first electrical contact positioned and arranged to contact one of a positive terminal and a negative terminal of the battery, and a second housing slideably attached to the first housing, the second housing including a second electrical contact positioned and arranged to contact the other of the positive terminal and the negative terminal of the battery.

In another embodiment, at least one of the first and second electrical contacts includes copper.

In another embodiment, the first housing includes a first aperture and the second housing includes a second aperture, and the first electrical contact is attached to an inner surface of the first aperture and the second electrical contact is attached to an inner surface of the second aperture.

In another embodiment, at least one of the first and second housings includes a power outlet, the power outlet powered by power drawn from the battery.

In another embodiment, the power outlet is a USB outlet.

In another embodiment, the second housing is slideably attached to the first housing by a sliding mechanism that slides within a recess of one of the first and second housings.

In another embodiment, the portable device further includes a biasing mechanism to bias the second housing towards or away from the first housing.

In another embodiment, at least one of the first and second housings includes a clamp positioned and arranged to clamp a battery terminal, the clamp including the first or second electrical contact.

In a general embodiment, a portable device capable of converting power from a battery includes a housing including an outer surface, a first aperture located on the outer surface of the housing, the first aperture including a first electrical contact positioned and arranged to contact one of a positive terminal and a negative terminal of the battery, a second aperture located on the outer surface of the housing, the second aperture including a second electrical contact positioned and arranged to contact the other of the positive terminal and the negative terminal of the battery, at least one power outlet operably connected to the housing, and electronic circuitry electrically connecting the first electrical contact, the second electrical contact and the at least one power outlet, the electronic circuitry configured to convert the power from the battery to power useable by the at least one power outlet.

In another embodiment, the at least one power outlet is located on the outer surface of the housing.

In another embodiment, the electronic circuitry is configured to convert the power from the battery to power useable by the power outlet by (i) stepping down the power from the battery to a lower voltage, or (ii) inverting the power from the battery from DC power to AC power.

In another embodiment, the housing includes a first housing slideably connected to a second housing, the first housing including the first aperture and the second housing including the second aperture.

In another embodiment, at least one of the first and second housings includes a biasing mechanism to bias the second housing towards or away from the first housing.

In another embodiment, the biasing mechanism is at least one of an elastomeric band and a spring.

In another embodiment, the first electrical contact is attached to an inner surface of the first aperture and the second electrical contact is attached to an inner surface of the second aperture.

In another embodiment, the electronic circuitry is further configured to store the power from the battery so that the power can be supplied to the at least one power outlet when the first and second electrical contacts do not contact the positive and negative terminals of the battery.

In a general embodiment, a method of drawing power from a battery includes lining up a first aperture of a first housing with one of a positive terminal and a negative terminal of the battery, sliding a second housing along a sliding mechanism connecting the second housing to the first housing to line up a second aperture of the second housing with the other of the positive terminal and the negative terminal of the battery, placing the first and second housings over the positive and negative terminals so that the positive terminal enters one of the first aperture and the second aperture and the negative terminal enters the other of the first aperture and the second aperture, electrically connecting the first housing to one of the first aperture and the second aperture, electrically connecting the second housing to the other of the first aperture and the second aperture, and drawing power from the battery.

In another embodiment, the method includes at least one of: (i) stepping down the power drawn from the battery to a lower voltage; or (ii) converting the power drawn from the battery from DC power to AC power.

In another embodiment, the method includes supplying the stepped down power or AC power to a power outlet.

In another embodiment, the method includes biasing the second housing towards or away from the first housing.

An advantage of the present disclosure is to draw power from an automobile battery to power or charge an electronic device or appliance.

Another advantage of the present disclosure is to provide a compact, portable device that can quickly be attached to a battery to draw power from the battery.

### BRIEF DESCRIPTION OF THE FIGURES

Embodiments of the present disclosure will now be explained in further detail by way of example only with reference to the accompanying figures, in which:

FIG. 1 depicts a top perspective view of an embodiment according to the present disclosure of a portable device capable of drawing power from a battery;

FIG. 2 depicts a top perspective view of the portable device of FIG. 1 in an open configuration;

FIG. 3 depicts a bottom perspective view of the portable device of FIG. 1 in an open configuration;

FIG. 4 depicts a bottom plan view of the portable device of FIG. 1 in an open configuration;

FIG. 5 depicts an exploded view of the portable device of FIG. 1;

FIG. 6 depicts a cross-sectional view of the portable device of FIG. 1 taken across lines 6-6 in FIG. 4;

FIG. 7 depicts a cross-sectional view of the portable device of FIG. 1 taken across lines 7-7 in FIG. 4;

FIG. 8 depicts an exploded view of an alternative embodiment according to the present disclosure of a portable device capable of drawing power from a battery;

FIG. 9 depicts a cross-sectional view of the portable device of FIG. 9 taken across lines 9-9;

FIG. 10 depicts a cross-sectional view of the portable device of FIG. 9 taken across lines 10-10;

FIG. 11 depicts a top perspective view of an alternative embodiment according to the present disclosure of a portable device capable of drawing power from a battery;

FIG. 12 depicts a cross-sectional view of an alternative embodiment according to the present disclosure of a portable device capable of drawing power from a battery;

FIG. 13 depicts a cross-sectional view of an alternative embodiment according to the present disclosure of a portable device capable of drawing power from a battery;

FIG. 14 depicts a cross-sectional view of an alternative embodiment according to the present disclosure of a portable device capable of drawing power from a battery;

FIG. 15 depicts a cross-sectional view of an alternative embodiment according to the present disclosure of a portable device capable of drawing power from a battery;

FIG. 16 depicts a top perspective view of an alternative embodiment according to the present disclosure of a portable device capable of drawing power from a battery;

FIG. 17 depicts a top perspective view of an alternative embodiment according to the present disclosure of a portable device capable of drawing power from a battery; and

FIG. 18 depicts a top perspective view of an alternative embodiment according to the present disclosure of a portable device capable of drawing power from a battery.

### DETAILED DESCRIPTION

Before the disclosure is described, it is to be understood that this disclosure is not limited to the particular apparatuses and methods described. It is also to be understood that the terminology used herein is for the purpose of describing particular embodiments only, and is not intended to be limiting, since the scope of the present disclosure will be limited only to the appended claims.

As used in this disclosure and the appended claims, the singular forms “a,” “an” and “the” include plural referents unless the context clearly dictates otherwise. The methods and apparatuses disclosed herein may lack any element that is not specifically disclosed herein. Thus, “comprising,” as used herein, includes “consisting essentially of” and “consisting of.”

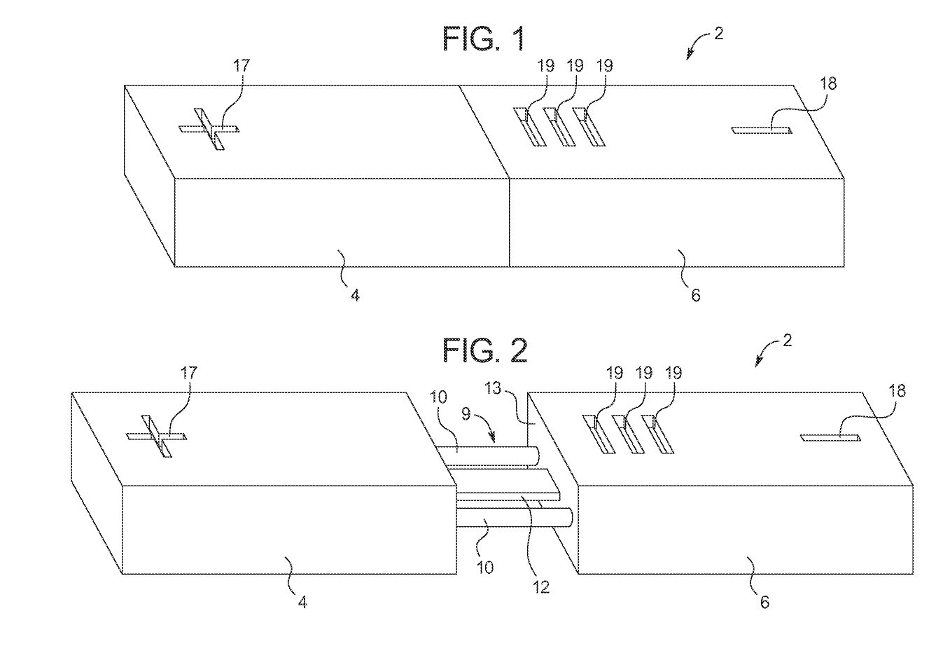

FIGS. 1 to 7 illustrate an example embodiment of a portable device 2 capable of drawing power from a battery such as a 12 V automobile battery. In an embodiment, the battery can be a car battery, a truck battery, a motorcycle battery, a moped battery, a marine battery or any other battery known in the art. In an embodiment, the battery can be a 6 V, 12 V, 25 V or any other voltage battery suitable for powering a power outlet, as discussed below.

Device 2 includes a positive, or first, housing 4 and a negative, or second, housing 6. As used herein, the terms “positive” housing and “negative” housing are merely used to explain that one housing is removably attached to the positive terminal of a battery and the other housing is removably attached to the negative terminal of the battery. It should be understood that every element of a “positive” housing described herein can instead be included in a “negative” housing according to the present disclosure, and every element of a “negative” housing described herein can instead be included in a “positive” housing according to the present disclosure. The “positive” and “negative” housings can also be referred to simply as “first” and “second” housings or “second” and “first” housings, respectively, and are interchangeable besides the fact that only one housing can electrically connect to a positive terminal and the other housing to a negative terminal. Positive housing 4 and negative housing 6 can be formed of any suitable material, for example, a plastic such as acrylic.

In the embodiment shown, positive housing 4 is slideably, or adjustably, attached to negative housing 6 by at least one sliding mechanism 9, for example, one or more sliding bars 10. Sliding mechanism allows positive housing 4 and negative housing 6 to adjustably slide, or translate, with respect to each other so that positive housing 4 and negative housing 6 can be configured to be removably attached to positive and negative battery terminals. Once attached to the positive and negative battery terminals, device 2 is capable of drawing power from the battery, converting the power for example by either stepping down the power to a lower voltage or inverting DC power to AC power, and providing the stepped-down power or AC power to a power outlet 19, for example, a USB outlet or standard plug outlet such as a two or three pin outlet or a socket outlet, or any other standard or unique outlet that needs less power than the battery provides or runs off of AC power. Because many cellular phones, computers and other portable electronic devices are powered via USB or standard plug outlets, device 2 can advantageously be used to provide stepped down DC power or AC power to such devices in the event of a power outage. In an embodiment, the USB outlet can be any standard universal serial bus outlet that supports power charging, for example, an outlet configured to accept a Standard-A plug, a Standard-B plug, a Micro-A plug, a Micro-B plug, a Mini-A plug, a Mini-B plug, the corresponding receptacles of such plugs, or any other universal serial bus plug or receptacle known in the art.

FIG. 1 shows device 2 in a compact, stored configuration, and FIG. 2 shows device 2 in an open configuration. Device 2 can be adjusted to a plurality of different open configurations to accommodate a variety of different battery types and sizes, for example, automobile batteries with different distances between positive and negative terminals. In use, device 2 can be slideably adjusted so that positive housing 4 can be placed in electrical contact with the positive terminal of a battery and negative housing 6 can be placed in electrical contact with the negative terminal of the same battery. In the embodiment shown, positive housing 4 is marked by a positive indicia 17, and negative housing 6 is marked by a negative indicia 18. Positive indicia 17 and negative indicia 18 allow a user to quickly and easily determine that positive housing 4 should be placed in electrical contact with the positive terminal of a battery and negative housing 6 should be placed in electrical contact with the negative terminal of the battery. Positive housing 4 and negative housing 6 can also be colored differently, for example black and red, respectively, to match the standard colors of the positive and negative terminals of a battery and allow a user to quickly differentiate the positive and negative contacts.

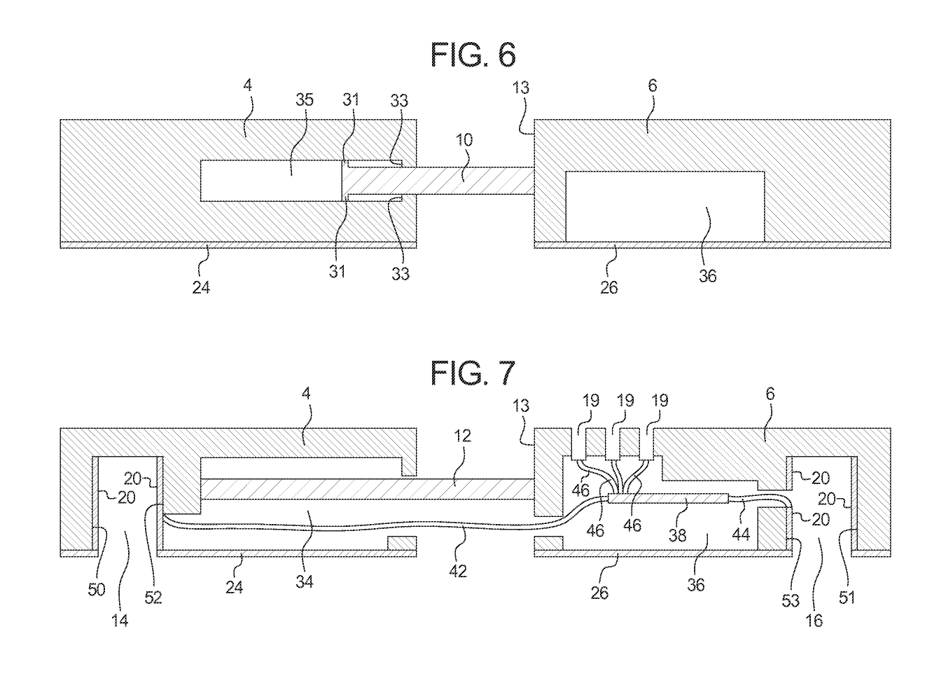

FIG. 2 shows that sliding mechanism 9 includes two sliding bars 10 slideably and adjustably attaching positive housing 4 to negative housing 6. Alternative embodiments of a sliding mechanism 9 can include only one sliding bar, one or more sliding or hinged bars, or other sliding mechanisms known in the art. In the embodiment shown, sliding bars 10 are affixed to outer surface 13 of negative housing 6 and slide within recesses 35 (FIG. 6) of positive housing 4 to allow positive housing 4 to adjustably slide with respect to negative housing 6. Alternatively, a sliding bar 10 can be affixed to an inner surface of negative housing 6 and/or to an outer or inner surface of positive housing 4 and/or slide within a recess of negative housing 6 to allow negative housing 6 to adjustably slide with respect to positive housing 4. Further alternatively, a first sliding bar 10 can be affixed to positive housing 4 and a second sliding bar 10 can be affixed to negative housing 6, and the first and second sliding bars 10 can slide with respect to each other to allow positive housing 4 and negative housing 6 to adjustably slide with respect to each other. Sliding bar 10 can also include depth markings to indicate the appropriate positioning for different battery types. In an embodiment, device 2 can be configured to lock into particular open configurations at particular depths, or positive housing 4 and negative housing 6 can adjustably slide with respect to each other in increments. Positive housing 4 and/or negative housing 6 can also include finger grips in the form of protrusions from and/or indents into an outer surface of the housings so that a user can grip the housings for adjustment.

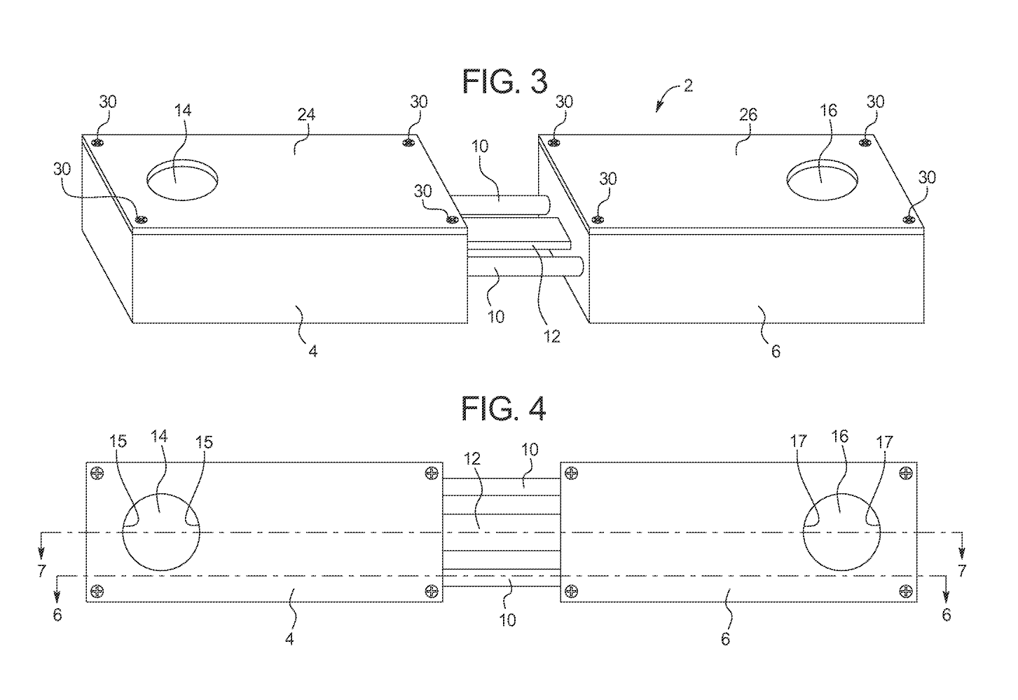

FIGS. 3 and 4 show bottom views of device 2. As understood by those of ordinary skill in the art, both positive housing 4 and negative housing 6 must include an electrical contact and form an electrical circuit for device 2 to receive power from a battery. In the embodiment shown, device 2 includes a positive aperture 14 configured to receive the positive terminal of a battery and a negative aperture 16 configured to receive the negative terminal of the battery. Positive aperture 14 and negative aperture 16 each include electrical contacts 20 with an electrically conductive material. In an embodiment, the inner surfaces 15 and 17 of positive aperture 14 and negative aperture 16, respectively, are each lined with an electrical contact 20, for example a copper mesh material. In alternative embodiments, the positive and negative apertures can be lined with or partially or fully include an electrical contact including any electrically conductive material known in the art, for example, metals such as copper, aluminum, steel, gold, calcium, tungsten, zinc, nickel, lithium, iron, platinum, tin, lead and titanium, non-metals such as graphite, solutions of salts and plasmas, or the like. Those of ordinary skill in the art will recognize other suitable electrically conductive materials that can be included in the electrical contacts 20 of the positive and negative apertures.

Device 2 can include a positive housing cover 24 and a negative housing cover 26. In the embodiment shown in FIG. 3, positive housing cover 24 and negative housing cover 26 are removably attached to positive housing 4 and negative housing 6, respectively, by screws 30. In an alternative embodiment, positive housing cover 24 and negative housing cover 26 can be removably attached to positive housing 4 and negative housing 6, respectively, by any other type of fastener, for example, bolts, clamps, magnets, clips, rivets, joints, pins or any other type of mechanical fastener known to those of ordinary skill in the art. Positive housing cover 24 and negative housing cover 26 can provide access to electronic circuitry including wiring that connects the electrical contact 20 of aperture 14, the electrical contact 20 of aperture 16, and the power outlets 19, as well as a circuit board for controlling various functions of device 2 and for converting the power from the battery by stepping down the power to a lower voltage to charge a portable device or by converting DC power to AC power to charge a portable device.

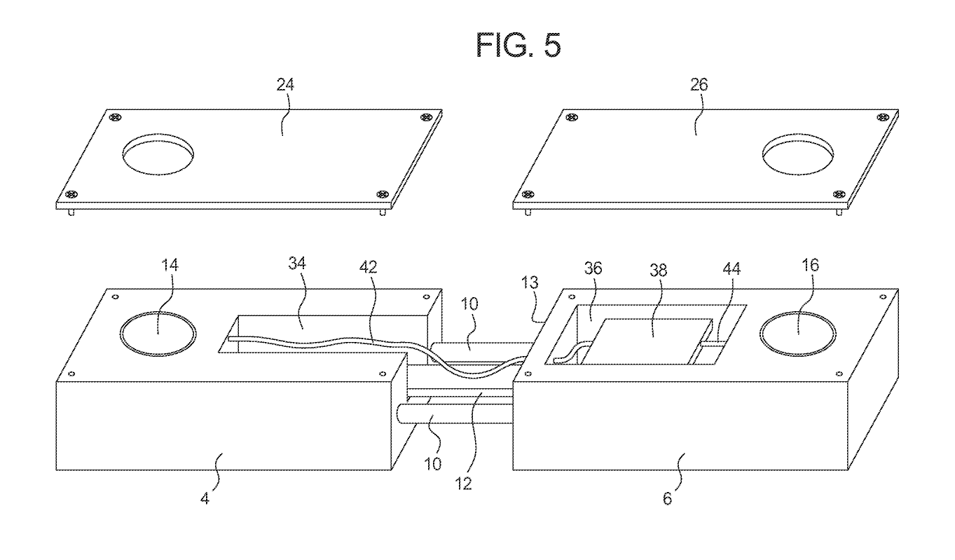

FIG. 5 shows an exploded view of device 2 in which positive housing cover 24 and negative housing cover 26 have been removed from positive housing 4 and negative housing 6, respectively. As illustrated, negative housing 6 includes a recess 36 and a circuit board 38, and positive housing includes a recess 34. In the embodiment shown, sliding bars 10 are affixed to negative housing 6 and slide within recesses 35 of positive housing 4 to allow positive housing 4 to adjustably slide with respect to negative housing 6. FIG. 6 shows a sliding bar 10 within recess 35 of positive housing 4. Sliding bar 10 includes one or more projections 31 that prevent sliding bar 10 from sliding past an edge 33 of recess 35 so that positive housing 4 does not detach from negative housing 6. The configuration of the sliding bars 10 with respect to positive housing 4 and negative housing 6 can also be reversed.

In use, positive housing 4 and negative housing 6 are slideably attached to each other by sliding mechanism 9 so that positive housing 4 and negative housing 6 can be slideably, or translationally, adjusted to line up positive aperture 14 and negative aperture 16 with the positive and negative terminals, respectively, of any sized battery regardless of the distance or orientation of the positive and negative terminals of the battery. When positive aperture 14 is lined up with the positive battery terminal and negative aperture 16 is lined up with the negative battery terminal, device 2 can be placed on the battery so that the positive battery terminal enters positive aperture 14 and the negative battery terminal enters negative aperture 16. Device 2 can draw DC power from the battery as long as the positive terminal of the battery contacts the electrical contact 20 of positive aperture 14 and the negative terminal of the battery contacts the electrical contact 20 of negative aperture 16. That DC power can then be stepped down or can be converted to AC power.

Positive aperture 14 and negative aperture 16 should be sized to fit over a plurality of different sized battery terminals and therefore will have a larger diameter than the battery terminals, for example, about 0.75 inches. In an embodiment, positive aperture 14 and negative aperture 16 can be sized differently to prevent a user from attaching device 2 to a battery incorrectly and causing a short circuit. Because positive aperture 14 and negative aperture 16 will be larger than the battery terminals, positive housing 4 and negative housing 6 can be slightly adjusted after placement on respective positive and negative battery terminals to force the battery terminals into contact with the electrical contacts 20 on the inner surfaces 15,17 of the respective apertures 14, 16 of the respective housings 4, 6. In an embodiment, positive housing 4, negative housing 6, and/or sliding bar 10 can include, be located adjacent to, or be operatively connected to one or more biasing mechanisms 11. In the embodiment shown, the biasing mechanism is an elastomeric band 12. In alternative embodiments described herein, the biasing mechanism can also be, for example, one or more springs. Other suitable biasing mechanisms in place of and/or in addition to an elastomeric band or springs will be recognized by those of ordinary skill in the art.

In the embodiment shown, elastomeric band 12 is affixed to positive housing and negative housing 6 and is located primarily within recess 34 of positive housing 4. Elastomeric band 12 biases positive housing 4 and negative housing 6 towards each other. When a biasing mechanism 11 such as elastomeric band 12 is used to bias positive housing 4 and negative housing 6 towards each other, the biasing force of elastomeric band 12 will cause a positive battery terminal to contact an outer portion of inner surface 15 of positive aperture 14 and will cause a negative battery terminal to contact an outer portion 51 of inner surface 17 of negative aperture 16. Likewise, one or more biasing mechanisms 11 can be used to bias positive housing 4 and negative housing 6 away each other, which will cause a positive battery terminal to contact an inner portion 52 of inner surface 15 of positive aperture 14 and will cause a negative battery terminal to contact an inner portion 53 of inner surface 17 of negative aperture 16. Such a biasing mechanism 11 also secures device 2 to the battery by the frictional force caused by the battery terminals pressing against the inner surfaces 15 and 17 of apertures 14 and 16.

In the embodiment shown, the electronic circuitry includes several wires 42, 44, 46 and a circuit board 38. A wire 42 connects circuit board 38 to the electrical contact 20 lining positive aperture 14, and a wire 44 connects circuit board 38 to the electrical contact 20 lining negative aperture 16. Additional wiring 46 connects circuit board 38 to each of the power outlets 19. In an embodiment, wire 42 can pass through a sliding mechanism 9 so as not to be exposed when device 2 is in an open configuration. In the embodiment shown, wire 42 is located so as to be easily accessed when positive housing cover 24 is removed from positive housing 4. In an alternative embodiment, both positive housing 4 and negative housing 6 can include a circuit board and/or one or more outlets 19. In an embodiment, electronic circuitry and/or circuit board 38 can include a microcontroller for stepping down the power to a lower voltage and/or an AC/DC inverter for converting DC power to AC power.

Circuit board 38 can be a standard circuit board capable of converting DC power from a battery by stepping down the DC power from the battery to a lower voltage DC power. Circuit board 38 can also be a standard circuit board capable of converting DC power from a battery by converting the DC power to AC power. Once the DC power has been converted as required, the battery can be used to power a power outlet 19, for example, a USB outlet or standard plug outlet such as a two or three pin outlet or a socket outlet. In an embodiment, the electronic circuitry can further include a safety device such as a surge protector which prevents a user from compromising the electric circuit if positive housing 4 is placed on a negative battery terminal and negative housing 6 is placed on a positive battery terminal. In an embodiment, the safety device is a Zener diode connected to the input wire and ground which permits reverse flow above a breakdown voltage and maintains the right voltage drop over a wide range of currents.

The electronic circuitry of device 2 can also include one or more indicators to indicate the power level of the battery, for example, one or more light-emitting diodes (“LEDs”). In an embodiment, device 2 can include a green LED, a yellow LED, and a red LED. The green LED can indicate when a battery is producing, for example, between 11.2 V to 12 V. The yellow LED can indicate when a battery is producing, for example, between 10 V to 11.2 V. The red LED can indicate when a battery is producing, for example, between 9 V to 10 V. Such a set of LEDs allows a user to quickly and easily determine the power level of a battery by simply attaching device 2 to the battery. In an alternative embodiment, device 2 can include a single LED that indicates when a battery meets a particular threshold, for example 10 V, or device 2 can include a display that indicates the exact or approximate voltage of a battery. In an embodiment, the electronic circuitry can also be configured to store DC power from the battery or inverted AC power so that device 2 can provide power to a power outlet 19 even after device 2 has been removed from a battery. Device 2 can include a power meter to indicate the power stored in device 2, or device 2 can include one or more indicator lights, such as LEDs, to indicate the power charging status of device 2.

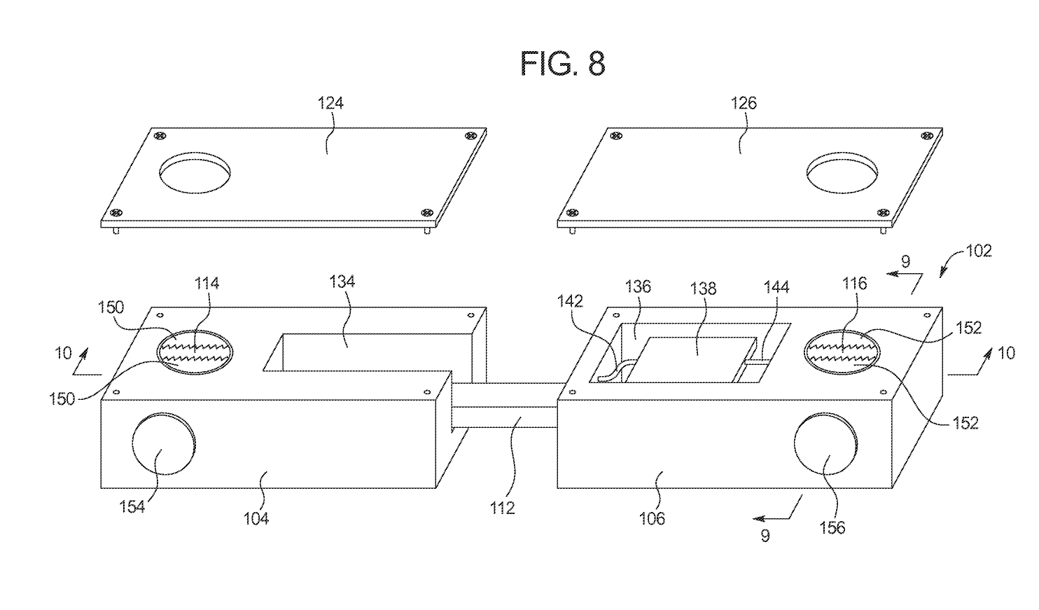

FIGS. 8 to 10 illustrate an alternative example embodiment of a portable device 102 capable of drawing power from a battery. Like device 2, device 102 includes a positive, or first, housing and a negative, or second, housing 106. Positive housing 104 is adjustably and slideably attached to negative housing 106 by a hollow sliding bar 112. Hollow sliding bar 112 allows positive housing 104 and negative housing 106 to adjustably slide with respect to each other to be removably attached to positive and negative battery terminals located along the same line.

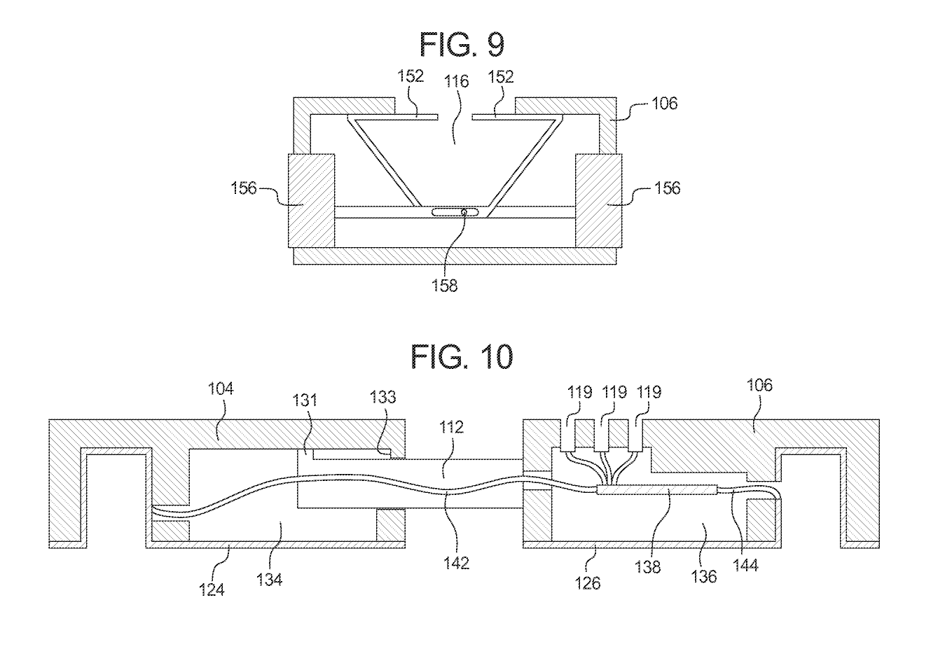

Device 102 differs from device 2 in that the positive housing 104 and negative housing 106 each include a respective clamp 150, 152. The clamps 150, 152 are activated by buttons 154, 156, respectively, on opposite sides of the housings 104, 106. As illustrated with respect to negative housing 116 in FIG. 9, buttons 156 are attached to clamps 152 such that pushing buttons 156 inward into negative housing 116 causes clamps 152 to be drawn outward from the center of aperture 116. To attach negative housing 116 to a negative battery terminal, a user can press buttons 156 inward, insert the battery terminal into aperture 116, and then release buttons 156 to cause clamps 152 to clamp the negative battery terminal. In the embodiment shown, clamps 152 include an electrical contact or are formed of an electrically conductive material such as copper so that clamping the negative terminal of the battery with clamps 152 causes an electrical contact between negative housing 106 and the negative battery terminal If the same process is followed for positive housing 4 using buttons 154 and clamps 150 to clamp the positive terminal of the same battery, the electrical contacts with both battery terminals allows device 102 to draw power from the battery. In an embodiment, each set of clamps can be connected with a pin 158 for stability. Those of ordinary skill in the art will recognize similar clamping mechanisms that accomplish the same purpose and can be integrated into a device according to the present disclosure.

Device 102 is constructed similar to device 2 in most other respects. Negative housing 106 includes a recess 136 and a circuit board 138 connected to the electrically conductive clamps 152 by a wire 144. Circuit board 138 is also connected to electrically conductive clamps 150 by a wire 142 that can pass through hollow sliding bar 112 so as not to be exposed outside of the housings. Circuit board 138 can also be connected to power outlets 119 on positive housing 104 and/or negative housing 106 via wires. Positive housing cover and negative housing cover 126 can be used to cover recess 134 of positive housing 104 and recess 136 of negative housing 106, respectively.

Device 102 can include one or more biasing mechanisms to bias positive housing 104 and negative housing 106 towards or away from each other. In the embodiment shown, however, device 102 does not include any biasing mechanism. Hollow sliding bar 112 is affixed to negative housing 106 and slides within recess 134 of positive housing 104 to allow positive housing 104 to adjustably slide with respect to negative housing 106. Because the clamps 150, 152 lock device 102 into place on the battery terminals and cause electrical contact with the battery terminals, spring biasing or other biasing is unnecessary to force an electrical connection. A user can slideably adjust positive housing 104 and negative housing 106 to line up with positive and negative battery terminals, respectively, and then clamp the positive and negative housings to the respective battery terminals with one motion. Once clamped, device 102 is locked into place and can provide power to one or more power outlets 119. Hollow sliding bar 112 also includes one or more projections 131 that prevent sliding bar 112 from sliding past an edge 133 of recess 134 so that positive housing 104 does not detach from negative housing 106. Any or all of the features of device 102 can be added to any of the other embodiments of devices described herein.

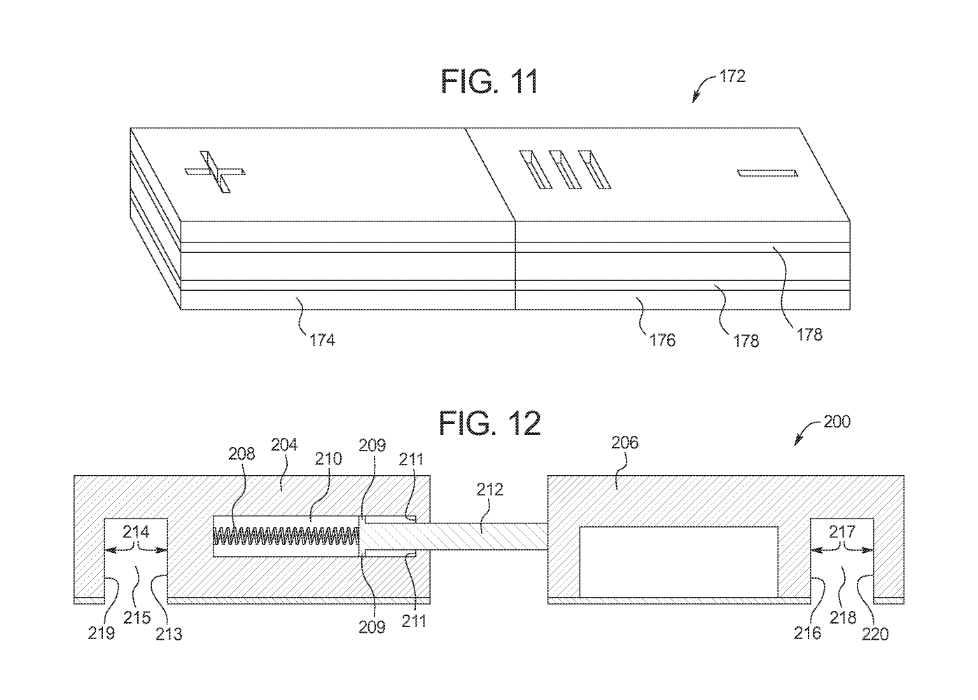

FIG. 11 illustrates another example embodiment of a portable device 172 including a positive housing 174 and a negative housing 176. Device 172 differs from device 2 in that the biasing mechanism includes elastomeric bands 178 located in grooves on the outer surface of positive housing 174 and negative housing 176. Like with device 2, elastomeric bands 178 bias positive housing 174 and negative housing 176 towards each other, causing a positive battery terminal to contact an inner surface of a positive aperture of positive housing 172 and causing a negative battery terminal to contact an inner surface of a negative aperture of negative housing 176. An advantage of locating elastomeric bands 178 in grooves on the outer surfaces of the housings is that it frees up space inside the housings for other components. Any or all of the features of device 172 can be added to any of the other embodiments of devices described herein.

FIG. 12 illustrates another example embodiment of a portable device 200 including a positive housing 204 and a negative housing 206. Like device 2, device 200 includes a sliding bar 212 that is affixed to negative housing 206 and slides within recess 210 of positive housing 204 to allow positive housing 204 to adjustably slide with respect to negative housing 206. The configuration of sliding bar 212 with respect to positive housing 204 and negative housing 206 can also be reversed.

Device 200 differs from device 2 in that the biasing mechanism includes one or more springs 208 located within recess 210 of positive housing 204 and adjacent to sliding bar 212. Spring 208 can be used to bias positive housing 204 and negative housing 206 towards or away from each other. In the embodiment shown, spring 208 biases sliding bar 212 and negative housing 206 away from positive housing 204. Sliding bar 212 also includes one or more projections 209 that prevent sliding bar 212 from sliding past an edge 211 of recess 210 so that positive housing 204 does not detach from negative housing 206.

When a biasing mechanism such as one or more springs 208 is used to bias positive housing 204 and negative housing 206 away from each other, the force of the spring(s) 208 will cause a positive battery terminal to contact an inner portion 213 of inner surface 214 of positive aperture 215 of positive housing 206 and will cause a negative battery terminal to contact an inner portion 216 of inner surface 217 of negative aperture 218 of negative housing 208. Likewise, one or more springs can be used to bias positive housing 204 and negative housing 206 towards each other, which will cause a positive battery terminal to contact an outer portion 219 of inner surface 214 of positive aperture 215 and will cause a negative battery terminal to contact an outer portion 220 of inner surface 217 of negative aperture 218. Such a biasing spring also secures device 200 to the battery by the frictional force caused by the battery terminals pressing against the inner surfaces 214 and 217 of apertures 215 and 218. Any or all of the features of device 200 can be added to any of the other embodiments of devices described herein.

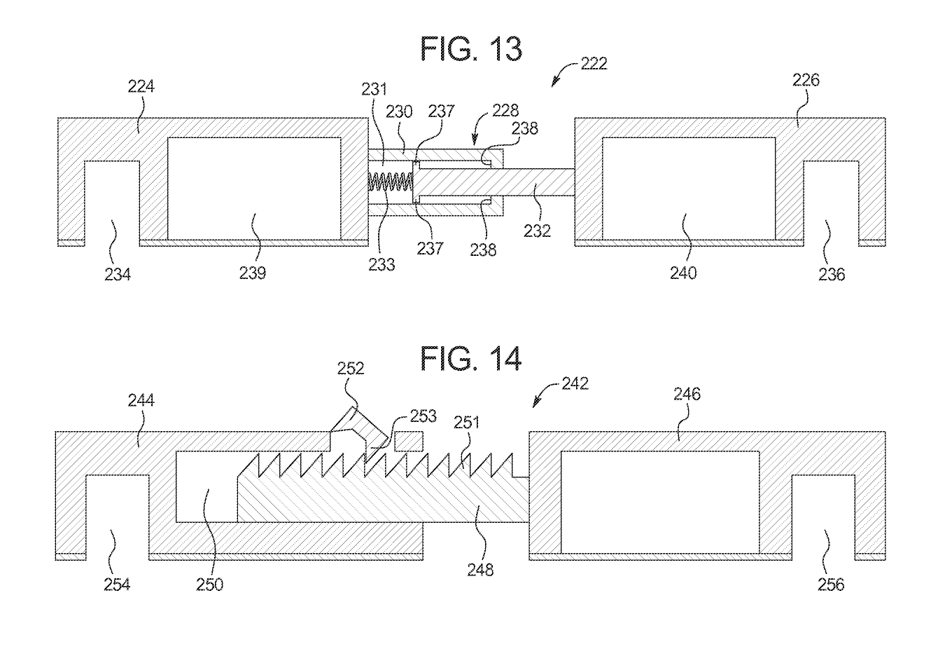

FIG. 13 illustrates another example embodiment of a portable device 222 including a positive housing 224 and a negative housing 226. Device 222 differs from device 2 in that the sliding mechanism 228 connecting positive housing 224 to negative housing 226 does not slide within either housing 224 or housing 226. Instead, sliding mechanism 228 includes an outer housing 230 and an inner bar 232. Outer housing 230 is attached to an outer surface of positive housing 224 and inner bar 232 is attached to an outer surface of negative housing 226. Inner bar 232 can slide within a recess 231 of outer housing 230 so that positive housing 224 and negative housing 236 can be slideably adjusted to line up positive aperture 234 and negative aperture 236 with the positive and negative terminals, respectively, of any sized battery regardless of the distance or orientation of the positive and negative terminals of the battery. Device 222 further includes a spring 233 located within recess 231 that biases inner bar 232 and negative housing 226 away from outer housing 230 and positive housing 224. Inner bar 232 includes one or more projections 237 that prevent inner bar 232 from sliding past an edge 238 of recess 231 so that inner bar 232 does not detach from outer housing 230. Sliding mechanism 228 is advantageous in that it allows more room for recesses 239 and 240 inside positive housing 224 and negative housing 226, respectively, for circuitry, wires and other components because there is no mechanism sliding within either of the housings. Any or all of the features of device 222 can be added to any of the other embodiments of devices described herein.

FIG. 14 illustrates an example embodiment of a portable device 242 including a positive housing 244 and a negative housing 246. Negative housing 246 includes a sliding bar 248 that slides within a recess 250 of positive housing 244. Sliding bar 248 includes teeth 251 that allow negative housing 246 to slide towards positive housing 244 but prevent negative housing 246 from sliding away from positive housing 244 unless button 252 is pressed to release teeth from attachment with a projection 253 of button 252. Due to the locking nature of the teeth, positive housing 244 and negative housing 246 can be slideably adjusted to line up positive aperture 254 and negative aperture 256 with the positive and negative terminals, respectively, of any sized battery and then locked into place in that configuration. Any or all of the features of device 242 can be added to any of the other embodiments of devices described herein.

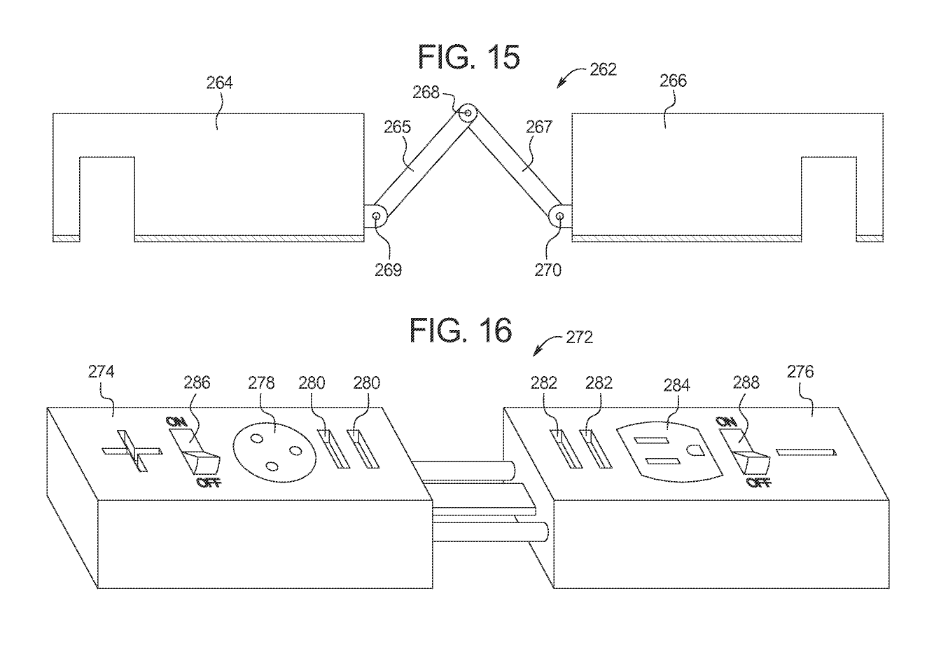

FIG. 15 illustrates an example embodiment of a portable device 262 including a positive housing 264 and a negative housing 266. Device 262 is similar to device 2 except that the sliding mechanism includes two sliding bars 265, 267 hingedly attached at a pin 268. Sliding bar 265 is also hingedly attached to positive housing 264 at pin 269, and sliding bar 267 is hingedly attached to negative housing 266 at pin 270. The three hinged attachments allow positive housing 264 and negative housing 266 to be slideably adjusted with respect to each other to line up with the positive and negative terminals, respectively, of any sized battery regardless of the distance or orientation of the positive and negative terminals of the battery. Any or all of the features of device 262 can be added to any of the other embodiments of devices described herein.

Portable devices capable of drawing power from a battery can also be used for a variety of other purposes besides powering a USB port as described above. FIG. 16 illustrates an example embodiment of a portable device 272 including a positive housing 274 and a negative housing 276. Positive housing 266 includes a three pin outlet 278 and two USB outlets 280, and negative housing 266 includes two USB outlets 282 and a standard plug outlet 284. Any other outlet that can be used to provide power to a consumer device or appliance can be substituted in place of three pin outlet 278, USB outlets 280, 282, and/or standard plug outlet 284. Positive housing also includes a switch 286 that controls power to three pin outlet 278 and USB outlets 280, and negative housing includes a switch 288 that controls power to standard plug outlet 284 and USB outlets 282. Alternatively, a single switch can control power to every outlet on both housings 274, 276, a separate switch can control each individual outlet, or device 272 can be manufactured without switches so that every outlet has continuous power when device 272 is attached to a battery. Further alternatively, a dial can replace one or more switches to either progressively control the power sent to the outlets or to control which outlets receive power. In an embodiment, device 272 can include one circuit board to step down DC power from a battery for all DC power outlets, and a second circuit board to convert DC power from a battery to AC power for all AC power outlets. In an embodiment, all DC power outlets can be included on one of the positive and negative housings, and all AC power outlets can be included on the other of the housings. Any or all of the features of device 272 can be added to any of the other embodiments of devices described herein.

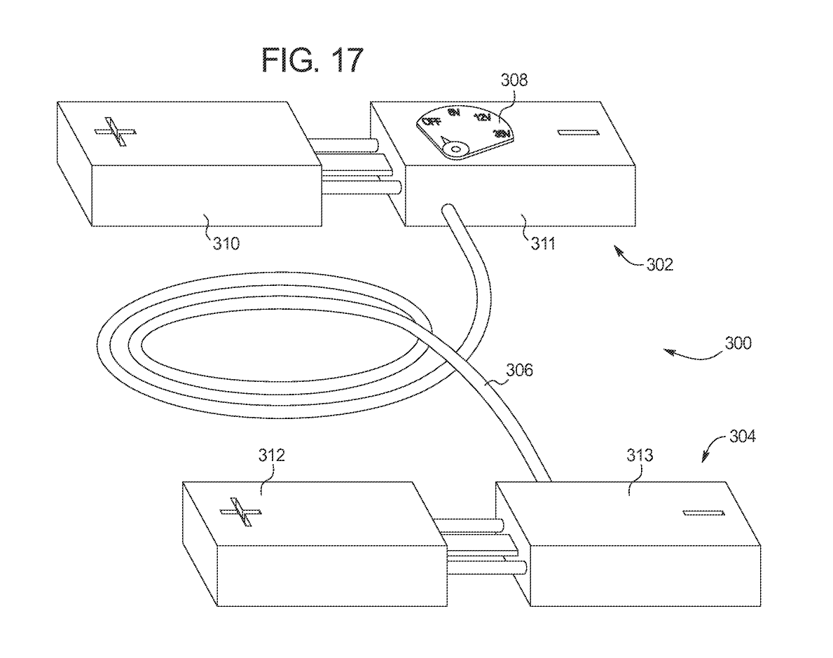

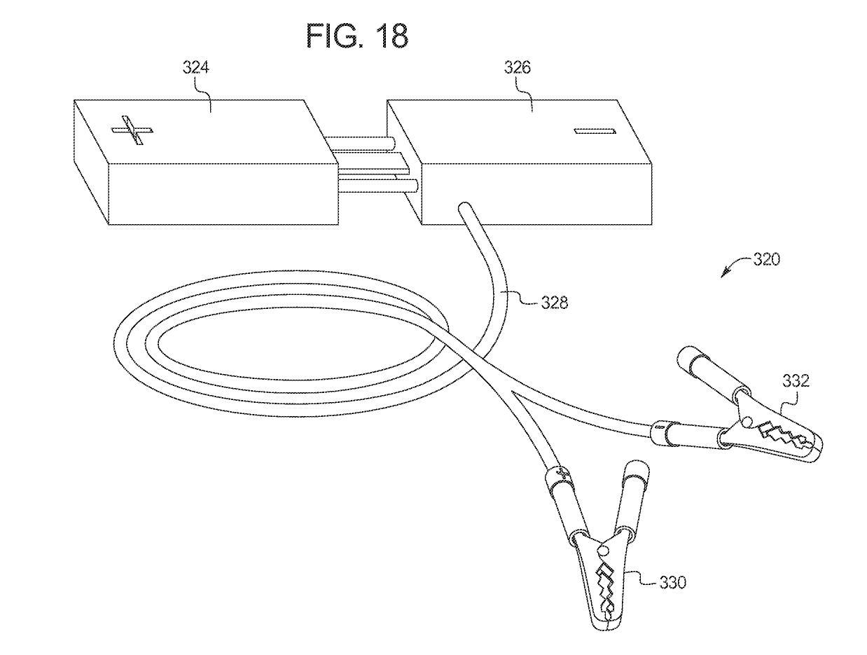

FIGS. 17 and 18 illustrate example embodiments of power transfer devices 300 and 320, respectively, that can be used to transfer power from one battery to another battery. Power transfer device 300 includes a device 302 and a device 304 connected by a cable 306. Device 300 is useful, for example, for jump-starting a dead battery from a charged battery. Devices 302 and 304 can include similar structure to devices 2, 102, 172, 200, 222, 242, 262 and 272 except that instead of powering a local outlet, devices 302 and 304 transfer power between each other. In an embodiment, device 302 can be connected to a charged battery by attaching positive housing 310 to the positive terminal of the charged battery and negative housing 311 to the negative terminal of the charged battery so as to draw power from the charged battery. Device 304 can then be connected to a dead battery by attaching positive housing 312 to the positive terminal of the dead battery and negative housing 313 to the negative terminal of the dead battery. Once devices 302 and 304 are both attached to batteries, device 302 can be used to send power from device 302 to device 304, and vice versa.

In the embodiment shown, device 302 further includes a dial 308 that allows a user to turn device 300 off so that no charge is sent from device 302 to device 304, or to adjust device 300 to send 6 V, 12 V, or 25 V from device to device depending on the types of batteries attached to devices 302 and 304. Dial 308 can be advantageous if different types of batteries are being connected to devices 302 and 304. For example, if a 12 V battery is attached to device 302 and is being used to jump-start a 6 V battery attached to device 304, dial 308 can be set to 6 V so that only 6 V is sent to device 304. Alternatively, an on/off switch can be used, or device can be manufactured without a dial so that power is automatically sent between devices 302 and 304. Any or all of the features of device 300 can be added to any of the other embodiments of devices described herein.

Device 320 includes similar structure except instead of a second positive and negative housing, device 320 includes terminal clamps 330, 332. Like device 300, device 320 is useful, for example, for jump-starting a dead battery from a charged battery. Device 320 can include similar structure to devices 2, 102, 172, 200, 222, 242, 262 and 272 except that instead of transferring power from a battery to a local outlet, device 320 transfers power between two batteries. In an embodiment, device 320 can be connected to a charged battery by attaching positive housing 324 to the positive terminal of the charged battery and negative housing 326 to the negative terminal of the charged battery so as to draw power from the charged battery. Terminal clamp 330 can then be connected to the positive terminal of a dead battery and terminal clamp 332 can be connected to the negative terminal of a dead battery. Although no dial is shown, device 320 can also include a dial similar to dial 308 to allow a user to turn device on or to send different charges based on different batteries. Any or all of the features of device can be added to any of the other embodiments of devices described herein.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A portable device capable of drawing power from a battery, comprising:
a first housing including a first electrical contact positioned and arranged to contact one of a positive terminal and a negative terminal of the battery;
a second housing slideably attached to the first housing, the second housing including a second electrical contact positioned and arranged to contact the other of the positive terminal and the negative terminal of the battery.

2. The device of claim 1, wherein at least one of the first and second electrical contacts includes copper.

3. The device of claim 1, wherein the first housing includes a first aperture and the second housing includes a second aperture, and wherein the first electrical contact is attached to an inner surface of the first aperture and the second electrical contact is attached to an inner surface of the second aperture.

4. The device of claim 1, wherein at least one of the first and second housings includes a power outlet, the power outlet powered by power drawn from the battery.

5. The device of claim 1, wherein the power outlet is a USB outlet.

6. The device of claim 1, wherein the second housing is slideably attached to the first housing by a sliding mechanism that slides within a recess of one of the first and second housings.

7. The device of claim 1, further including a biasing mechanism to bias the second housing towards or away from the first housing.

8. The device of claim 1, wherein at least one of the first and second housings includes a clamp positioned and arranged to clamp a battery terminal, the clamp including the first or second electrical contact.

9. A portable device capable of converting power from a battery, comprising:
a housing including an outer surface;
a first aperture located on the outer surface of the housing, the first aperture including a first electrical contact positioned and arranged to contact one of a positive terminal and a negative terminal of the battery;
a second aperture located on the outer surface of the housing, the second aperture including a second electrical contact positioned and arranged to contact the other of the positive terminal and the negative terminal of the battery;
at least one power outlet operably connected to the housing; and
electronic circuitry electrically connecting the first electrical contact, the second electrical contact and the at least one power outlet, the electronic circuitry configured to convert the power from the battery to power useable by the at least one power outlet.

10. The portable device of claim 9, wherein the at least one power outlet is located on the outer surface of the housing.

11. The portable device of claim 9, wherein the electronic circuitry is configured to convert the power from the battery to power useable by the power outlet by (i) stepping down the power from the battery to a lower voltage, or (ii) inverting the power from the battery from DC power to AC power.

12. The portable device of claim 9, wherein the housing includes a first housing slideably connected to a second housing, the first housing including the first aperture and the second housing including the second aperture.

13. The portable device of claim 12, wherein at least one of the first and second housings includes a biasing mechanism to bias the second housing towards or away from the first housing.

14. The portable device of claim 13, wherein the biasing mechanism is at least one of an elastomeric band and a spring.

15. The portable device of claim 9, wherein the first electrical contact is attached to an inner surface of the first aperture and the second electrical contact is attached to an inner surface of the second aperture.

16. The portable device of claim 9, wherein the electronic circuitry is further configured to store the power from the battery so that the power can be supplied to the at least one power outlet when the first and second electrical contacts do not contact the positive and negative terminals of the battery.

17. A method of drawing power from a battery, comprising:
lining up a first aperture of a first housing with one of a positive terminal and a negative terminal of the battery;
sliding a second housing along a sliding mechanism connecting the second housing to the first housing to line up a second aperture of the second housing with the other of the positive terminal and the negative terminal of the battery;
placing the first and second housings over the positive and negative terminals so that the positive terminal enters one of the first aperture and the second aperture and the negative terminal enters the other of the first aperture and the second aperture;
electrically connecting the first housing to one of the first aperture and the second aperture;
electrically connecting the second housing to the other of the first aperture and the second aperture; and
drawing power from the battery.

18. The method of claim 17, which includes at least one of: (i) stepping down the power drawn from the battery to a lower voltage; or (ii) converting the power drawn from the battery from DC power to AC power.

19. The method of claim 18, which includes supplying the stepped down power or AC power to a power outlet.

20. The method of claim 17, which includes biasing the second housing towards or away from the first housing.
